(19) United States
(12) Patent Application Publication
(10) Pub. No.: US 2006/0053373 A1
(43) Pub. Date: Mar. 9, 2006

(54) Method for adding interactivity to a recording

(75) Inventors: Jingwei Tan, Shanghai (CN); Declan P Kelly, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/540,190

(22) PCT Filed: Dec. 12, 2003
(86) PCT No.: PCT/IB03/06057

§ 371 Date: Jun. 20, 2005

Related U.S. Application Data
(60) Provisional application No. 60/435,231, filed on Dec. 20, 2002.

(51) Int. Cl. H04N 5/44; G06F 17/24; G06F 17/21

(52) U.S. Cl. 715/716; 715/512; 715/500.1

(57) ABSTRACT

A user commands a recording device (10) to store a recording (71) on a removable recording medium (70). The user selectively adds interactivity to the recording (70). In response to any added interactivity, the recording device (10) links the recording (71) and an interactive module (72) that is based on the added interactivity. The interactive module and an interactive link (73) representative of the link between the recording (71) are both stored on the removable recording medium (70).

The present invention generally relates to a removable recording medium for recording audio data and/or visual data, such as, for example, a Compact-Disc (“CD”) and a Digital Videodisc (“DVD”). The present invention specifically relates to an addition of interactivity to the audio data and/or visual data as recorded on the removable recording medium.

Currently, various storage formats of a recorded interactive television program are being defined. The efforts in this area are directed to satisfying an anticipated desire by television viewers in interacting with digital televisions. It is also anticipated that users of digital recording devices (e.g., a digital camcorder) will also desire an interactive functioning of the device. Therefore, there is a need to develop a storage format of a stored recording within such devices.

One form of the present invention is a method of operating various types of recording devices (e.g., camcorders, CD players, DVD players and other recording devices as known in the art). First, a recording (e.g., an audio track, a video clip, an audio/visual clip and other types of recordings known in the art) is stored on a removable recording medium (e.g., an optical disk, a cassette, and other types of removable recording mediums known in the art) as commanded by a user of the recording device. Second, interactivity is added to the recording as commanded by the user of the recording device. Third, the recording and an interactive module based on the interactivity added to the recording are linked. Fourth, the interactive module is stored on the removable recording medium. Fourth, Finally, an interactive link representative of the link between the recording and the interactive module is stored on the removable recording medium.

The foregoing form as well as other forms, features and advantages of the present invention will become further apparent from the following detailed description of the presently preferred embodiments, read in conjunction with the accompanying drawings. The detailed description and drawings are merely illustrative of the present invention rather than limiting, the scope of the present invention being defined by the appended claims and equivalents thereof.

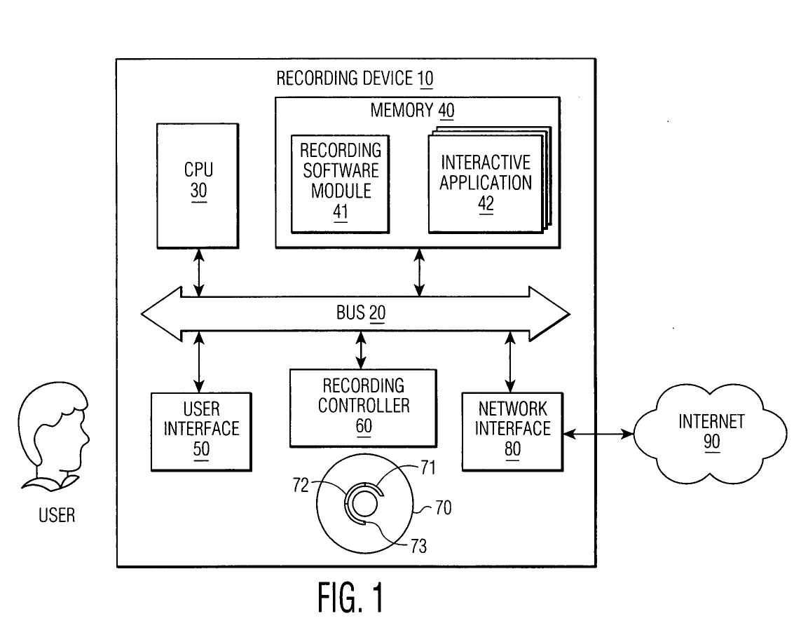

FIG. 1 illustrates a block diagram of audio/visual recorder in accordance with one embodiment of the present invention;

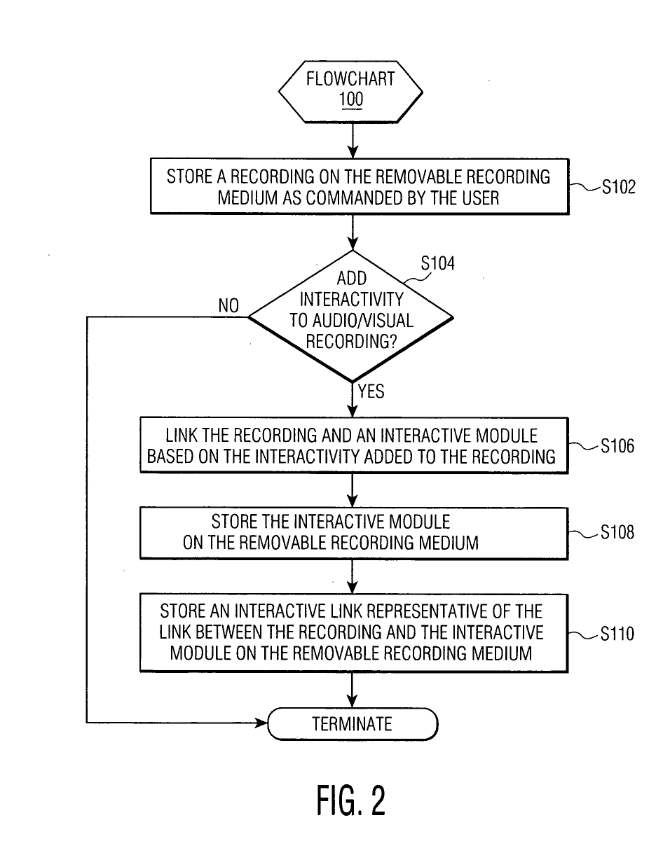

FIG. 2 illustrates a flowchart representative of an interactive storage method in accordance with one embodiment of the present invention;

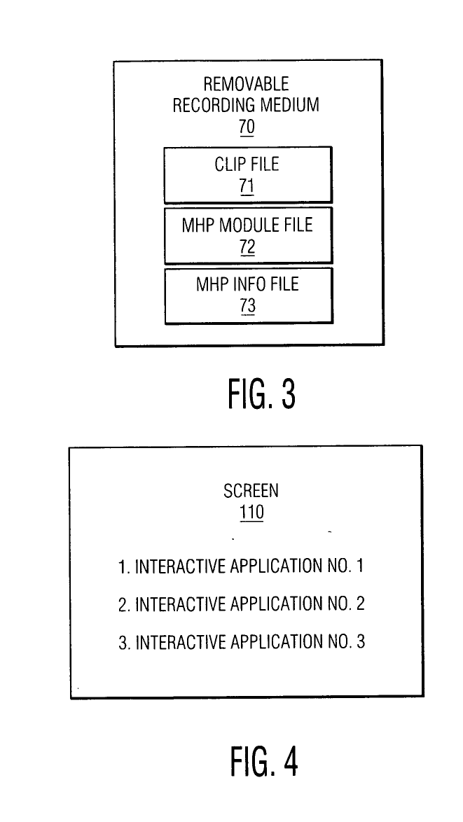

FIG. 3 illustrates an optical disc in accordance with one embodiment of the present invention; and

FIG. 4 illustrates a first graphical user interface in accordance with one embodiment of the present invention.

FIG. 1 illustrates a recording device (“RD”) 10 employing a bus 20 for facilitating communication between a central processing unit (“CPU”) 30, a memory (“MEM”) 40, a user interface (“UI”) 50, a recording controller (“RC”) 60, and a network interface (“NI”) 80. As illustrated, the memory 40 stores a recording software module 41. The central processing unit 30 implements the recording software module 41 to conventionally store a recording 71 on a removable recording medium 70 in the form of an optical disc via recording controller 60 as commanded by a user via user interface 50. In accordance with an interactive storage method of the present invention, the central processing unit 30 further implements the recording software module 41 to store an interactive module 72 and an interactive link 73 on removable recording medium 70 via the recording controller 60.

FIG. 2 illustrates a flowchart 100 representative of the interactive storage method of the present invention. During a stage S102 of the flowchart 100, the central processing unit 30 controls a conventional storage of the recording 71 on the removable recording medium as commanded by the user via user interface 50. In one embodiment, the recording 71 is a conventional clip file (“CF”) as illustrated in FIG. 3.

During a stage S104 of the flowchart 100, the central processing unit 30 determines whether the user inputs an indication to add interactivity to the recording 71 as stored on the removable recording medium. In one embodiment, a graphical user interface presents specific screens and menus to the user during stage S104 whereby the user can choose to add interactivity to the recording 71. FIG. 4 illustrates an exemplary screen 120 that may be presented during stage S104. As illustrated in FIG. 1, the interactive application(s) listed on screen 20 can be interactive application(s) 42 stored within the memory 40 and/or interactive application(s) downloaded via the network interface 80 from a network, such as, for example, the Internet 90 as illustrated in FIG. 1. In one embodiment, each interactive application 42 includes a description file that is parsed by user interface 50 when implementing the graphical user interface whereby the user can add the interactivity to the recording in a way that is meaningful to the user.

If the user does not desire to add interactivity to the recording 71, then the central processing unit 30 terminates flowchart 100.

If the user adds interactivity to the audio/visual recoding 71, then the central processing unit 30 proceeds to a stage S106 of the flowchart 100 to link the recording 71 and an interactive module 72 based on the interactivity added to the recording 71 by the user (i.e., interactive module 72 includes portions of each selected interactive application(s) 42 and any other software necessary to display the interactivity as stored as added to the recording 71). The types and degree of linking of the recording 71 and the interactive module 72 is without limit. In one embodiment, the linking involves identifying a main entrance within recording 71 for executing interactive module 72, identifying any trigger moment information for the interactive module 72, and other links as would occur to those having ordinary skill in the art.

During a stage S108 of the flowchart 100, the central processing unit 30 controls storage of interactive module 72 to the removable recording medium 70. In one embodiment, the interactive module 72 is a conventional MHP module file (“MHP MOD”) as illustrated in FIG. 3.

During a stage S110 of the flowchart 100, the central processing unit 30 controls storage of an interactive link 73 that is representative of the linking between the recording 71 and the interactive module 72. In one embodiment, the interactive link 73 is a MHP info file (“MHP INFO”) as illustrated in FIG. 3 that primarily includes the name of the interactive module 72, the size of interactive module 72, the main entrance for executing interactive module 72, the structure of interactive module 72 (it is like a file system), the trigger moment information for the interactive module 72 if it has this function to trigger some pop-up information, and other information as would occur to those having ordinary skill in the art.

A working example of recording device 10 as a camcorder involves a recording 71 of a beautiful scene on removable recording medium 70 by a user of recording device 10. Wishing to add interactivity to the recording 71, the user selects an interactivity option from a first menu. This selection causes a second menu to pop up for the user to choose from interactive applications 42 stored in memory 40 or from a download of interactive applications 42 from a website on Internet 90. Under either choice, a third menu listing the template(s) for the selected interactive application 42 pops up whereby the user chooses a scene interactive application template. Using the template, the user inputs the location name of the recorded scene (e.g., Eindhoven central market) and a brief introduction having a date and a purpose of the recording 71. The user further chooses an important moment in the recorded scene, adds a fancy image to the recorded scene, and presses a label/button to show a word and an image in the recorded scene. From the Internet 90, the user downloads a news application that has the news the day the user recorded recording 71.

Upon completion, recording 71, interactive module 72 and interactive link 73 are stored on the removable recording medium 70 in accordance with flowchart 100 (FIG. 2). Subsequently, the removable recording medium 70 can be removed from recording device 70 and inserted into another recording device whereby anyone watching the recording 71 can observe the added interactivity (e.g., learn the name and purpose of recording 71, view an inserted fancy scene, and read the news on the day of the recording).

For facilitating an understanding of the present invention, the various stages S102-S110 of flowchart 100 (FIG. 2) were sequentially described. In practice, the various stages of S102-S110 of flowchart 100 can be sequentially performed as described herein, or in any other order suitable for meeting the demands of the user of a recording device implementing flowchart 100.

It is important to note that FIGS. 1-5 illustrate specific applications and embodiments of the present invention, and is not intended to limit the scope of the present disclosure or claims to that which is presented therein. Upon reading the specification and reviewing the drawings hereof, it will become immediately obvious to those skilled in the art that myriad other embodiments of the present invention are possible, and that such embodiments are contemplated and fall within the scope of the presently claimed invention.

While the embodiments of the invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

1. A method (S100) of operating a recording device (10), said method comprising:
(S102) storing a recording (71) on a removable recording medium (70) as commanded by a user of the recording device (10);
(S104) adding interactivity to the recording as commanded by the user of the recording device (10); and
(S106) linking the recording (71) and an interactive module (72) based on the interactivity added to the recording (71).

2. The method (100) of claim 1, further comprising:
(S108) storing the interactive module (72) on the removable recording medium (70), the interactive module (72).

3. The method of claim 1, further comprising:
(S110) storing an interactive link (73) on the removable recording medium (70), the interactive link (73) representative of the linking of the recording (71) and the interactive module (72).

4. A recording device (10), comprising;
means (41) for storing a recording (71) on a removable recording medium (70) as commanded by a user of said recording device (10);
means (42) for adding interactivity to the recording as commanded by the user of the recording device (10); and
means (41) for linking the recording (71) and the interactive module (72) based on the interactivity added to the recording (71).

5. The recording device (10) of claim 4, further comprising:
means (41) for storing the interactive module (72) on the removable recording medium (70), the interactive module (72) corresponding to the interactivity added to the recording (71).

6. The recording device (10) of claim 4, further comprising:
means (41) for storing an interactive link (73) on the removable recording medium (70), the interactive link (73) representative of the linking of the recording (71) and the interactive module (72).
